(19) United States
(12) Patent Application Publication
(10) Pub. No.: US 2006/0031279 A1
(43) Pub. Date: Feb. 9, 2006

(54) Highly parallel structure for fast multi cycle binary and decimal adder unit

(75) Inventors: Wilhelm Haller, Remshalden (DE); Wen He Li, Poughkeepsie, NY (US); Michael R. Kelly, Wappingers Falls, NY (US); Holger Wetter, Weil im Schoenbuch (DE)

Correspondence Address: John E. Campbell;IBM Corporation, 2455 South Road, P386, Poughkeepsie, NY, 12601, US

(73) Assignee: International Business Machines Corporation, Armonk, NY (US)

(21) Appl. No.: 11/175,489

(22) Filed: Jul. 6, 2005

(30) Foreign Application Priority Data
Aug. 5, 2004 (EP) 04103765.6

(51) Int. Cl. G06F 7/50

(52) U.S. Cl. 708/670

(57) ABSTRACT

An adder circuit for adding two binary or two decimal operands A and B in which the carries are calculated directly from the input operands A and B without including the plus 6 or minus 6 operations into the carry calculation. For all timing critical functions the reduced input data set, i.e., valid decimal data can be used and the non-existing decimal numbers (10 to 15) need not be excluded by separate check logic any more. This reduces the complexity of the logic functions.

### TECHNICAL FIELD

The present invention relates to an adder circuit for adding two floating point operands A and B, and in particular, it refers to such adder circuit handling decimal operands, wherein each decimal digit 0 to 9 has a binary 4-bit representation.

### BACKGROUND OF THE INVENTION

In a decimal adder, any of the decimal digits 0 to 9 is represented by a 4-bit group. As 4 bits naturally cover the range from decimal 0 to 15, usually the unused six highest groups 1010 , 1011, 1100, 1101, 1110, 1111 corresponding to decimal 10, 11, 12, 13, 14, 15 are excluded from further calculation.

There is a growing need for decimal arithmetic and calculation in current high-end computer systems. This involves even floating point decimal numbers. The width of the operands of this kind of applications is in the range of 32 or even more digits (>128 bits). A one-cycle approach for current GigaHertz designs is therefore not achievable anymore. Instead, multiple execution cycles are necessary. However, this results in new critical paths and requires structural changes to prior art adder solutions.

State of the art solutions handle operand length of 64 bit length. With reference U.S. Pat. No. 6,292,819, which is incorporated herein by reference, this can be done in one cycle of currently available processing units. In this kind of prior art adder structures there is one most critical path through the carry logic (denoted C1 in FIG. 2 of above US patent), which generates the carries into each digit.

In particular, for decimal add operations in a particular “decimal adaptation circuit” referred herein as “pre-sum logic” a (decimal) digitwise operation (operand A plus Operand B plus 6) is performed according to prior art. The carry out of a digit indicates if a conditional correction to the digit sum has to be done.

For decimal subtraction a respective subtraction of operand A minus operand B is performed in said pre-sum circuit, and the digit sum is reduced by 6 if the carry out is 0. Otherwise the sum is already correct.

In parallel to the main carry network C1, which generates the ‘hot’ carries into each digit, all possible digit sum calculations for add/sub are thus prepared. This is: A plus B plus 6, A plus B, A minus B, and A minus B minus 6, each of these pre-sums are performed with an assumed carry-in of 0 and 1, respectively. Depending on the operation the appropriate carry-out of the 4-digit pre-sum Cy0 to Cy3 defines the correct choice of the digit sum, by indicating if or if not a correction to the digit sum is required.

With reference back to timing purposes it can be seen, that the path thru the pre-sum logic to Cy0, Cy1, Cy2, Cy3 and then to the select signals of multiplexer M50 and M60 competes with the delay of the carry logic to generate the carries into each digit (CyIn). For a single-cycle approach, where the carry logic has to handle operand length of 64 bits, this is no problem. The carry generation 12 is clearly the most critical net.

For a multi-cycle approach, however, as imposed by the high clock frequencies of several Gigahertz, where the chunks of the handled operands are smaller, e.g. 16 bits, the competition is very strong, as the carry generation logic is relatively faster. The path delay to generate the select signals of multiplexers M50 and M60 are equal to the delay for generating the Carry-Ins. Thus, the pre-sum logic is disadvantageously too slow, and thus the ADDCYOUT and SUBCARRYOUT signals and the respective multiplexer control signals arrive too late at the multiplexer M70 combining the input signals from the carry generation logic and the pre-sum logic. Thus, disadvantageously, this prior art circuit cannot be used for high clock frequencies and shorter operands, as e.g. 32-bit in a 2-cycle adder structure.

### SUMMARY OF THE INVENTION

It is thus an objective of the present invention to provide an adder circuit, which overcomes the before-mentioned disadvantage.

This objective of the invention is achieved by the features stated in enclosed independent claims. Further advantageous arrangements and embodiments of the invention are set forth in the respective subclaims. Reference should now be made to the appended claims.

According to its most basic aspect, the present invention discloses an adder circuit for adding two decimal operands A and B, wherein each decimal digit 0 to 9 has a binary 4-bit representation, and a digitwise operand A plus operand B plus 6 operation is performed, wherein the carry-out of a digit is indicating, if or if not a correction to the digit sum is required, said adder circuit comprising: a) a first carry subcircuit for generating “hot” carries into each digit, b) a second adder subcircuit for precalculating all possible digit sums A plus B, A minus B, A plus B plus 6, and A minus 6 minus B, for both, assumed carry-in values of 0 and 1, characterized by: c) a pre-sum logic for calculating the carry out cy0, cy1, cy2 and cy3 directly from the input operands, d) said pre-sum logic implementing the following formula (1) or a logical equivalent thereof:
Cy0=g0+(g1*p0)+(g2*p0*p1)+(g3*p0*p1*p2);
Cy1=g0+(g1*p0)+(g2*p0*p1)+(p0*p1*p2*p3);
Cy2=g0+(p0*p1)+(p0*p2)+(p0*g3)+(g1*p2)+(g1*g3)+(g1*g3)+(p1*g2*g3);
Cy3=g0+(p0*p1)+(p0*p2)+(p0*p3)+(g1*p2)+(g1*p3)+(p1*g2*p3);

with the following Notation

g=generate with gi=Ai*Bi,

P=propagate with pi=Ai+Bi

+=logical OR

*=logical AND

The present invention thus introduces a new logic structure, in which the carries are calculated directly from the input operands A and B, to avoid the critical paths to the select signals Se10, Se11, Se12, and to Se13. Further, the inventional carry generation avoids including the plus 6 or minus 6 operations into the carry calculation. In other words, the timing critical gating of carries out of the pre-sum logic blocks is not used any more.

For all timing critical functions the reduced input data set, i.e., valid decimal data can be used and the non-existing decimal numbers (10 to 15) need not be excluded by separate check logic any more. This reduces the complexity of the logic functions.

Further, the selection of multiplexers M1, M2 is now orthogonal, i.e., the signal Sel_mux0/2 is the complement of (Sel₁₃mux1/3), as it is required that the multiplexers implement “XOR” behaviour, if fast transmission gate multiplexers are used. Thus, this condition is automatically true, and the circuit is very fast, as it needs no respective priority logic.

The Cy0, Cy1 input is fixed, i.e., the A operand positive, B operand being negative is only needed for subtraction mode.

And the Cy2, Cy3 input is fixed, the A operand and B operand being positive is only used for addition mode. Thus, advantageously, no switching device is required for switching between addition and subtraction.

Further, the present invention is basically suitable for an ultra-fast adder structures, where the word length is reduced, e.g. in the case of 2-cycle structures, where blocks of 16 bits are processed.

Cy0 to Cy3 represent the functions A plus/minus B plus C, where C is a constant 0, 1, 6, or 7. If ever required the inventional method may be used therefore also in the context of non-decimal adders and for add operations having more than one carry in a single digit positions, a 3-port addition with a limited input range.

The present invention is applicable for both, integer and floating point as well as for binary and decimal (fix point and floating point) operations. Thus, the present invention is not specific for floating point operations.

### BRIEF DESCRIPTION OF THE DRAWINGS

The present invention is illustrated by way of example and is not limited by the shape of the figures of the drawings in which:

FIG. 1 is a block diagram representation of the carrypart of a prior art 64-bit decimal adder;

FIG. 2 is a respective block diagram representation of an adder according to the invention; and

FIG. 3 is an overview table illustrating the settings of control signals any_add, dec_add, dec_sub and their respective function.

### BEST MODE FOR CARRYING OUT THE INVENTION

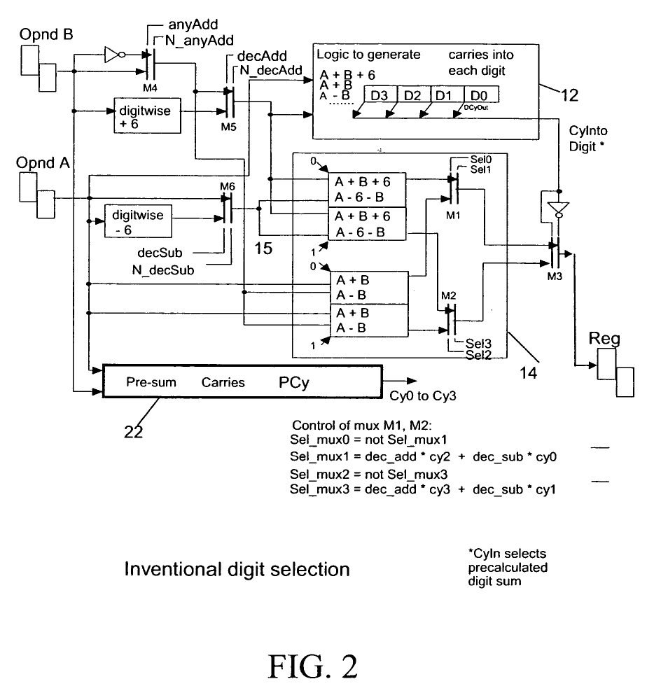

With general reference to the figures and with special reference now to FIG. 2 a preferred embodiment of an inventional digit selection circuit of an adder is described in more detail, which is applicable advantageously for decimal arithmetic and calculation in current high-end computer systems for operands having a length of 128 bits or wider, in which groups of 4 bits represent one decimal digit. The figure illustrates the processing of one of such decimal digits. The actual addition is not focussed by the present invention.

It should be noted that in the drawings the notation “A+B” means the operation of adding something and not a logical OR Operation. “A−B” means subtracting, respectively.

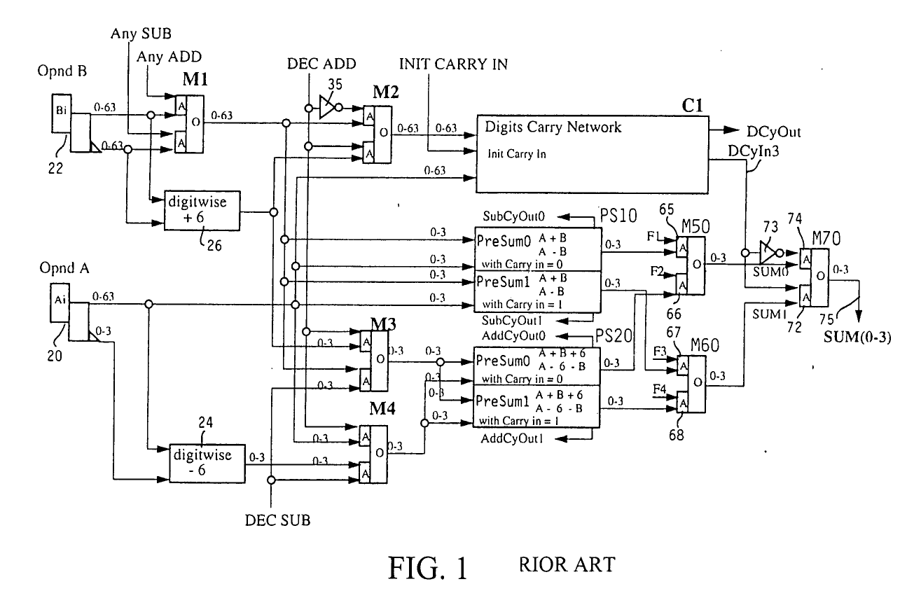

The adder section has in its upper part of the drawing a similar structure as cited in FIG. 1 for prior art. It can be used for decimal add/sub operation as well as for binary operation dependent of control signals as follows:

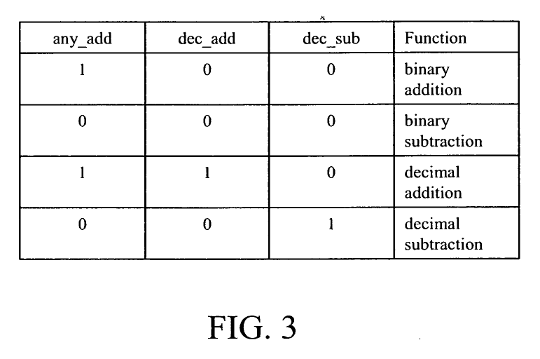

If the control signals denoted as dec_add (decimal add) and dec_sub (decimal sub) controlling multiplexer M5 and M6 are not orthogonal, the adder structure performs a binary addition/subtraction by default. This is the case when dec_add=0 and dec_sub=0, see also FIG. 3.

The four subcircuits within frame 14 are constructed similarly and work as described in said above cited US patent, see the description of FIG. 2 therein, except the generation of the carry out values Cy0, Cy1, Cy2, Cy3. For binary operation only the lower two subcircuits are used, for decimal operation, all four subcircuits are used.

According to the inventional embodiment, a logic block 22, denoted as “pre-sum carries PCY” generates carry signals Cy0 to Cy3 associated with the 4 bits of the decimal system directly from the source operands A and B. This logic block has advantageously direct inputs from input operands A and B, as it may be seen from the figure. The pre-sum logic block 22 generates the Carries Cy0 to Cy3 according to the formulas (1A) to (1D):
Cy0=g0+(g1*p0)+(g2*p0*p1)+(g3*p0*p1*p2); 1(A):
Cy1=g0+(g1*p0)+(g2*p0*p1)+(p0*p1*p2*p3); 1(B):
Cy2=g0+(p0*p1)+(p0*p2)+(p0*g3)+(g1*p2)+(g1*g3)+(p1*g2*g3); 1(C):
Cy3=g0+(p0*p1)+(p0*p2)+(p0*p3)+(g1*p2)+(g1*p3)+(p1*g2*p3); 1(D):
with generate signal: gi=Ai*Bi Propagate signal: pi=Ai+Bi for i=0.3

This generation of the carries is done in parallel to the digit wise plus/minus 6 logic, the multiplexers M5/M6, and the sum generation of the blocks calculating A±B and A+B+6/A−6−B.

The control of the multiplexer M1 and M2 is done with signals as follows:

Sel_mux0=not(Sel_mux1)

Sel_mux1=(dec_add*cy)+(dec_sub*not(cy0))

Sel_mux2=not(Sel_mux3)

Sel_mux3=(dec_add*cy3)+(dec_sub*not(cy1))

Thus, the inverted select signal mux_sell is equivalent to mux_se10 and the inverted signal mux_se13 is equal to mux_se12 as cited already above to be advantageous.

With the above formulas (1A) to (1D) the select signals at the multiplexers M1 and M2 can keep up with the timing of the select at multiplexer M3 processing signals from the carry generation circuit 12 and from pre-sum logic 14. Advantageously, only three control signals control the function of the units as it is depicted in FIG. 3.

As a person skilled in the art may appreciate, the present invention addresses the digit carry generation for the conditional correction of digit sums. The inventional features do not restrict the default mode of operation, which is a binary addition or subtraction.

Further, the inventional principle may also be used for covering 3-cycle or more-cycle add operations with respective larger operand width.

What is claimed is:

1. An adder circuit for adding either binary or decimal operands, the operands comprising a first operand to a second operand, the first operand comprising a plurality N of 4 bit digits A, a first operand digit represented by A(N-1), the second operand comprising the plurality N of 4 bit digits B, a second operand digit represented by B(N-1), the adder circuit comprising:
a) a first decimal digit sum calculator adapted to calculate digit sums, the digit sums for each digit of the plurality of N digits, the first decimal digit sum calculations comprising:
A(N-1) plus B(N-1) plus 6,
A(N-1) minus B(N-1) minus 6,
A(N-1) plus B(N-1), and
A(N-1) minus B(N-1);
b) a second decimal digit sum calculator adapted to calculate digit sums, the digit sums for each digit of the plurality of N digits, the second decimal digit sum calculations comprising:
A(N-1) plus B(N-1) plus 6 plus 1,
A(N-1) minus B(N-1) minus 6 plus 1,
A(N-1) plus B(N-1) plus 1, and
A(N-1) minus B(N-1) plus 1;
c) a carry subcircuit generating “hot” carries into digits of the plurality of N digits; d) a pre-sum circuit for calculating a carry-out cy0-cyN directly from the plurality of digits of the first and second operands; and
e) a final sum circuit generating final digit sums of the plurality of digits by selecting digit sums of the digit calculator based on respective digit carry-out of the pre-sum circuit and respective “hot” carries of the carry subcircuit.

2. The adder circuit according to claim 1 wherein the pre-sum circuit comprises pre-sum logic implementing the following formula or a logical equivalent thereof:
Cy0=g0+(g1*p0)+(g2*p0*p1)+(g3*p0*p1*p2),
Cy1=g0+(g1*p0)+(g2*p0*p1)+(p0*p1*p2*p3),
Cy2=g0+(p0*p1)+(p0*p2)+(p0*g3)+(g1*p2)+(g1*g3)+(p1*g2*g3),
Cy3=g0+(p0*p1)+(p0*p2)+(p0*p3)+(g1*p2)+(g1*p3)+(p1*g2*p3)
wherein:
* represents a logical <AND>
g(n)=A(n) <AND> B(n), and
p(n)=A(n) <OR> B(n).

3. The adder circuit of claim 1, wherein a number of 36 4-bit digits is calculated in two cycles for performing a decimal add operation or a binary add operation.

4. The adder circuit of claim 1, wherein a switching control is provided for a selection between binary and decimal operation mode.

5. The adder circuit of claim 4, wherein the switching control circuit selects a decimal first decimal digit sum calculation and decimal second decimal digit sum calculation for decimal operands and a binary first decimal digit sum calculation and binary second decimal digit sum calculation for binary operands.

7. The adder circuit of claim 1, wherein 16-bit operands are processed within one cycle.

8. The adder circuit of claim 1, wherein the adder circuit is a component of a computer system.

9. An adder circuit method for adding either binary or decimal operands, the operands comprising a first operand to a second operand, the first operand comprising a plurality N of 4 bit digits A, a first operand digit represented by A(N-1), the second operand comprising the plurality N of 4 bit digits B, a second operand digit represented by B(N-1), the method comprising:
a) a first decimal digit sum calculator calculating digit sums, the digit sums for each digit of the plurality of N digits, the first decimal digit sum calculations comprising:
A(N-1) plus B(N-1) plus 6,
A(N-1) minus B(N-1) minus 6,
A(N-1) plus B(N-1), and
A(N-1) minus B(N-1);
b) a second decimal digit sum calculator calculating digit sums, the digit sums for each digit of the plurality of N digits, the second decimal digit sum calculations comprising:
A(N-1) plus B(N-1) plus 6 plus 1,
A(N-1) minus B(N-1) minus 6 plus 1,
A(N-1) plus B(N-1) plus 1, and
A(N-1) minus B(N-1) plus 1;
c) a carry subcircuit generating “hot” carries into digits of the plurality of N digits;
d) a pre-sum circuit calculating a carry-out cy0-cyN directly from the plurality of digits of the first and second operands; and
e) a final sum circuit generating final digit sums of the plurality of digits by selecting digit sums of the digit calculator based on respective digit carry-out of the pre-sum circuit and respective “hot” carries of the carry subcircuit

10. The method according to claim 9 wherein the pre-sum circuit comprises pre-sum logic implementing the following formula or a logical equivalent thereof:
Cy0=g0+(g1*p0)+(g2*p0*p1)+(g3*p0*p1*p2),
Cy1=g0+(g1*p0)+(g2*p0*p1)+(p0*p1*p2*p3),
Cy2=g0+(p0*p1)+(p0*p2)+(p0*g3)+(g1*p2)+(g1*g3)+(p1*g2*g3),
Cy3=g0+(p0*p1)+(p0*p2)+(p0*p3)+(g1*p2)+(g1*p3)+(p1*g2*p3)
wherein:
* represents a logical <AND>,
+ represents a locical <OR>,
g(n)=A(n) <AND> B(n), and
p(n)=A(n) <OR> B(n).

11. The method according to claim 9, comprising the step of calculating a number of 36 4-bit digits in two cycles for performing a decimal add operation or a binary add operation.

12. The method according to claim 1, wherein a switching control provides the further step of selecting between a binary and a decimal operation mode.

13. The method according to claim 12, wherein the switching control circuit selects a decimal first decimal digit sum calculation and decimal second decimal digit sum calculation for decimal operands and a binary first decimal digit sum calculation and binary second decimal digit sum calculation for binary operands.

14. The method according to claim 9, comprising the step of processing 16-bit operands within one cycle.

15. The method according to claim 9, wherein the adder circuit is a component of a computer system.

16. An adder circuit for adding two binary or decimal operands A and B, wherein in case of decimal operands each decimal digit 0 to 9 has a binary 4-bit representation, and wherein decimal-digitwise operations are performed including a digit sum calculation of:
operand A plus operand B plus 6,
operand A minus operand B minus 6,
operand A plus operand B,
operand A minus operand B,
wherein the carry-out of a decimal digit is indicating if or if not a correction to the digit sum is required, said adder circuit comprising:
a) a first carry subcircuit for generating “hot” carries into each digit,
b) a second adder subcircuit for precalculating all possible digit sums A plus B, A minus B, and A plus B plus 6, and A minus 6 minus B for decimal operands, respectively, for both, assumed carry-in values of 0 and 1, characterized by
c) a pre-sum logic for calculating the carry-out cy0, cy1, cy2 and cy3 directly from the input operands,
d) said pre-sum logic implementing the following formula or a logical equivalent thereof:
Cy0=g0+(g1*p0)+(g2*p0*p1)+(g3*p0*p1*p2)
Cy1=g0+(g1*p0)+(g2*p0*p1)+(p0*p1*p2*p3)
Cy2=g0+(p0*p1)+(p0*p2)+(p0*g3)+(g1*p2)+(g1*g3)+(p1*g2*g3)
Cy3=g0+(p0*p1)+(p0*p2)+(p0*p3)+(g1*p2)+(g1*p3)+(p1*g2*p3)
wherein:
* represents a logical <AND>,
+ represents a locical <OR>,
g(n)=A(n) <AND> B(n), and
p(n)=A(n) <OR> B(n).
